(19) United States
(12) Patent Application Publication
(10) Pub. No.: US 2023/0226978 A1
(43) Pub. Date: Jul. 20, 2023

(54) REAR VIEW SYSTEM AND REAR VIEW METHOD FOR VEHICLE

(71) Applicants: Hyundai Motor Company, Seoul (KR); Kia Corporation, Seoul (KR)

(72) Inventors: Aakash S.K, Chennai (IN); Shyam Raman, Chennai (IN)

(21) Appl. No.: 17/683,828

(22) Filed: Mar. 1, 2022

(30) Foreign Application Priority Data
Jan. 14, 2022 (IN) 202211002274

(51) Int. Cl. B60R 1/26; B60R 11/04; B60R 1/12; H04N 7/18

(52) U.S. Cl. CPC B60R 1/26; B60R 11/04; B60R 1/12; H04N 7/183; B60R 2001/1253; B60R 2300/8026; B60R 2300/8066; B60R 2300/8046

(57) ABSTRACT

A rear view system for a vehicle includes: a transmitter configured to transmit a transmitter signal; a receiver configured to receive the transmitter signal and transmit information on whether the transmitter signal is received; a rear camera configured to capture a rear view of the vehicle, and transmit an image for the captured rear view of the vehicle; one or more displays mounted within the vehicle; and a controller configured to receive an image for a rear view of the vehicle from the rear camera in response to the reception of information indicating that the transmitter signal is not received from the receiver, and display the received image for the rear view of the vehicle on the one or more displays.

### CROSS-REFERENCE TO RELATED APPLICATION

This application claims priority to and the benefit of Indian Patent Application No. 202211002274 filed in the Indian Property Office on Jan. 14, 2022, the entire contents of which are incorporated herein by reference.

### BACKGROUND

### (a) Technical Field

The present disclosure relates to a rear view system and a rear view method for a vehicle, more particularly, to the rear view system and the rear view method that enable a driver to check a rear view of the vehicle even when the driver cannot see the rear side of the vehicle by using a rear-view mirror due to an occupant sitting on a rear seat or luggage or cargo blocking the driver's view.

### (b) Description of the Related Art

A rear-view mirror of a vehicle is mounted to a front side of a driver's seat in a vehicle, and promotes safe driving by allowing a driver to see a rear side of the vehicle. The rear-view mirror of the vehicle reflects a view of the rear side of the vehicle incident through a back window of the vehicle, so that when there is an object or an occupant between the rear-view mirror and the back window of the vehicle, the driver cannot see the view of the rear side of the vehicle through the rear-view mirror. In order to improve convenience and safety of driving, it would be desirable to develop a device or method capable of enabling a driver to check the rear side of the vehicle even when the driver cannot see the rear side of the vehicle through the rear-view mirror.

The matters described in the description of the related art are prepared to enhance the understanding of the background of the disclosure, and may include matters that are not already known to those skilled in the art to which the present technology belongs.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides a rear view system and a rear view method for a vehicle, which allow a driver to check a rear side of the vehicle even when the driver cannot see the rear side of the vehicle by using a rear-view mirror.

An exemplary embodiment of the present disclosure provides a rear view system, including: a transmitter configured to transmit a transmitter signal; a receiver configured to receive the transmitter signal and transmit information on whether the transmitter signal is received; a rear camera configured to capture a rear view of a vehicle, and transmit an image for the captured rear view of the vehicle; one or more displays mounted within the vehicle; and a controller configured to receive an image for a rear view of the vehicle from the rear camera in response to the reception of information indicating that the transmitter signal is not received from the receiver, and display the received image for the rear view of the vehicle on the one or more displays.

Another exemplary embodiment of the present disclosure provides a rear view method, including: transmitting, by a transmitter, a transmitter signal; transmitting, by a receiver, information on whether the transmitter signal is received; receiving, by a controller, an image for a rear view of a vehicle by operating a rear camera in response to reception of information indicating that the transmitter signal is not received; and displaying, by the controller, the received image for the rear view of the vehicle on one or more displays.

The transmitter signal may be infrared ray.

The one or more displays may be installed in at least one of a front window, a rear-view mirror, or an instrument panel.

The transmitter may be installed in a rear-view mirror, and the receiver may be installed in a lower portion of a back window or under the back window.

According to the exemplary embodiments of the present disclosure, in the case where a driver cannot see the rear side of the vehicle by using the rear-view mirror due to an occupant seat on a rear seat or luggage or cargo of a parcel tray, the view at the rear side of the vehicle is displayed on the display provided inside the vehicle, thereby enabling the driver to see the rear side of the vehicle. Accordingly, it is possible to reduce the risk of an accident during the operation of the vehicle and help the comfortable driving.

In addition, the effects obtainable or predicted by the exemplary embodiment of the present disclosure will be disclosed directly or implicitly in the detailed description of the exemplary embodiment of the present disclosure. That is, various effects predicted according to the exemplary embodiment of the present disclosure will be disclosed in the detailed description which is to be given below.

### BRIEF DESCRIPTION OF THE DRAWINGS

Exemplary embodiments of the present specification may be better understood by reference to the following description linked to the accompanying drawings in which similar reference numerals refer to the same or functionally similar elements.

FIG. 1 is a diagram schematically illustrating a vehicle to which a rear view system according to an exemplary embodiment of the present disclosure is applicable.

FIG. 2 is a diagram illustrating one example of a rear-view mirror included in the rear view system according to the exemplary embodiment of the present disclosure.

FIG. 3 is a diagram illustrating one example of an instrument panel of a vehicle.

FIG. 4 is a block diagram illustrating the rear view system according to the exemplary embodiment of the present disclosure.

FIG. 5 is a flowchart of a rear view method according to another exemplary embodiment of the present disclosure.

It should be understood that the foregoing referenced drawings are not necessarily illustrated in accordance with the scale, and they present somewhat brief expression of various preferred characteristics illustrating the basic principle of the present disclosure. For example, the specific design characteristics of the present disclosure including a specific dimension, direction, location, and shape may be partially determined by a particular intended application and use environment.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The terms used herein are for the purpose of describing specific exemplary embodiments, and are not intended to limit the present disclosure. As used herein, singular expressions include plural expressions unless they have definitely opposite meanings.

A rear view system according to an exemplary embodiment of the present disclosure acquires an image of a rear side of a vehicle by operating a rear camera when a receiver fails to receive a transmitter signal transmitted by a transmitter, and displays the acquired image of the rear side of the vehicle on a display within the vehicle.

Hereinafter, a rear view system according to an exemplary embodiment of the present disclosure and a rear view method using the same will be described in detail with reference to the accompanying drawings.

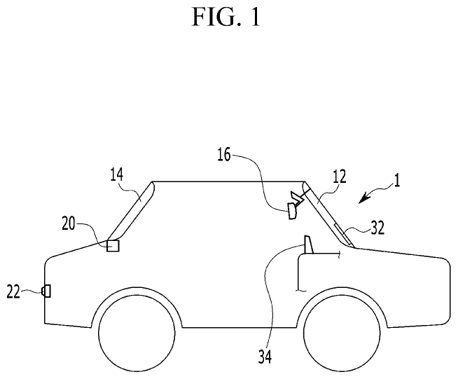

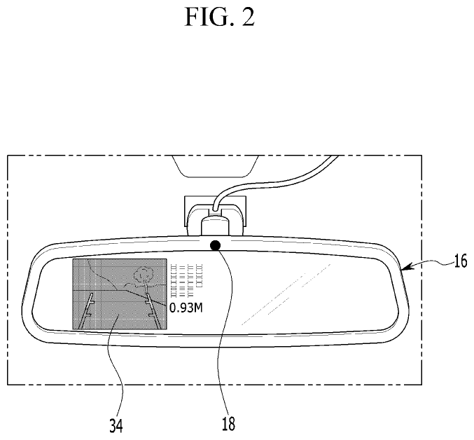

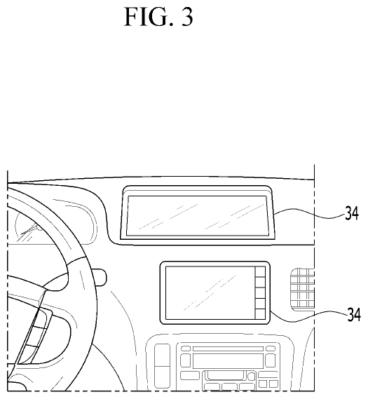

FIG. 1 is a diagram schematically illustrating a vehicle to which a rear view system according to an exemplary embodiment of the present disclosure is applicable, FIG. 2 is a diagram illustrating one example of a rear-view mirror included in the rear view system according to the exemplary embodiment of the present disclosure, and FIG. 3 is a diagram illustrating one example of an instrument panel of a vehicle.

As illustrated in FIG. 1, a rear view system according to an exemplary embodiment of the present disclosure is applied to a vehicle 1. The type of vehicle 1 is not particularly limited, and the exemplary embodiment of the present disclosure is applicable to the vehicle 1 having a structure in which a passenger seated on in the rear seat or luggage or cargo loaded in the parcel tray may prevent a driver from seeing the rear side of the vehicle 1 through a rear-view mirror 16.

A front window 12 is mounted to a front portion of the vehicle 1, and a rear window 14 is mounted to a rear portion of the vehicle 1. A predetermined position of the front window 12 functions as a head up display 32 to display information required by a driver or predetermined information.

A rear-view mirror 16 is mounted within the vehicle 1 at the rear side of the front window 12, so that the driver may view a rear view of the vehicle 1 through the rear-view mirror 16. That is, a light signal corresponding to the rear view of the vehicle 1 is incident to the rear-view mirror 16 through the rear window 14, and then is reflected from the rear-view mirror 16 to be incident to the eyes of the driver. Accordingly, the driver is capable of viewing the rear view of the vehicle 1 through the rear-view mirror 16. If a passenger, luggage, or cargo is positioned in a path of the light signal between the rear window 14 and the rear-view mirror 16, the driver may be prevented from seeing the rear view of the vehicle 1 through the rear-view mirror 16.

As illustrated in FIG. 2, a display 34 may be installed at a predetermined position of the rear-view mirror 16. The information required by the driver or the predetermined information may be displayed on the display 34 installed on the rear-view mirror 16. Further, a transmitter 18 may be mounted to a predetermined position of the rear-view mirror 16. The transmitter 18 transmits a transmitter signal, for example, infrared ray.

An instrument panel is installed in a front portion of the vehicle 1. As illustrated in FIG. 3, the display 34 is embedded in the instrument panel or mounted on the instrument panel, so that the information required by the driver or the predetermined information may be displayed on the display 34.

Herein, the example in which the front window 12 functions as the head up display 32, and the display 34 is mounted to the rear-view mirror 16 and/or the instrument panel is illustrated. However, the displays 32 and 34 may be mounted to at least one of the front window 12, the rear-view mirror 16, or the instrument panel. In addition, the displays 32 and 34 may also be installed in other positions within the vehicle 1.

A receiver 20 may be installed in a lower portion of the rear window 14 or under rear window 14 within the vehicle 1. The receiver 20 receives the transmitter signal transmitted by the transmitter 18. As described above, if a passenger, luggage, or cargo is positioned in a path of the light signal between the rear window 14 and the rear-view mirror 16, the driver may be prevented from seeing the rear view of the vehicle 1 through the rear-view mirror 16. In this case, the receiver 20 cannot receive the transmitter signal transmitted by the transmitter 18. The receiver 20 is positioned in the lower portion of the rear window 14 or under the rear window 14 within the vehicle 1, so that the path of the transmitter signal from the transmitter 18 installed in the rear-view mirror 16 to the receiver 20 in the lower portion of or under the rear window 14 overlaps the path of the light signal between the rear window 14 and the rear-view mirror 16. Accordingly, when the driver is prevented from seeing the rear view of the vehicle through the rear-view mirror 16, the receiver 20 cannot receive the transmitter signal transmitted by the transmitter 18.

A rear camera 22 is installed at the rear side of the vehicle 1, and the rear camera 22 may capture the rear view of the vehicle 1.

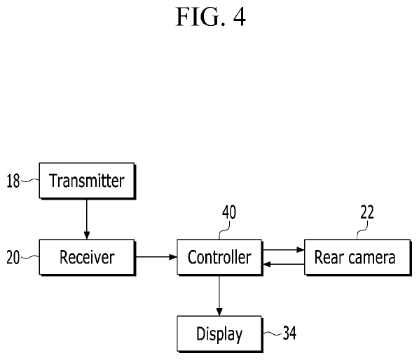

FIG. 4 is a block diagram of the rear view system according to the exemplary embodiment of the present disclosure.

As illustrated in FIG. 4, the rear view system according to the exemplary embodiment of the present disclosure may include the transmitter 18, the receiver 20, a controller 40, the rear camera 22, and one or more displays 32 and 34.

The transmitter 18 may be mounted to the rear-view mirror 16 to transmit a transmitter signal to the rear side. The transmitter signal is not limited thereto, and may be infrared ray so as not to damage the driver's eye. Further, the transmitter 18 may transmit a transmitter signal at all times while the vehicle 1 is operating, or transmit a transmitter signal at a predetermined time interval under the control of the controller 40.

The receiver 20 is installed in the lower portion of or under the rear window 14 within the vehicle 1, and receives the transmitter signal transmitted by the transmitter 18. The receiver 20 is communicatively connected to the controller 40 to transmit information on whether the transmitter signal is received to the controller 40.

The controller 40 receives information on whether the transmitter signal is received from the receiver 20. When information indicating that the receiver 20 fails to receive the transmitter signal is received, the controller 40 controls the rear camera 22 to capture the rear view of the vehicle 1 and transmit an image about the captured rear view of the vehicle 1 to the controller 40. Further, the controller 40 displays the image received from the rear camera 22 on at least one of the displays 32 and 34 within the vehicle 1. Accordingly, the driver may check the rear view of the vehicle 1 while viewing the image displayed on the displays 32 and 34. Since the displays 32 and 34 are positioned where the driver's field of vision is not obstructed, the driver is capable of easily checking the rear view of the vehicle 1 without obstruction, thereby reducing the risk of an accident and helping comfortable driving.

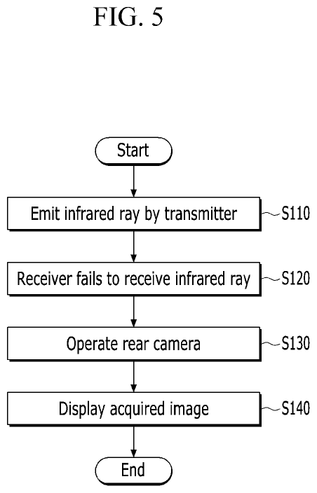

FIG. 5 is a flowchart of a rear view method according to another exemplary embodiment of the present disclosure.

As illustrated in FIG. 5, the transmitter 18 transmits a transmitter signal, for example, infrared ray, to the rear side while the vehicle 1 is operating (S110). When there is no occupant in a rear seat and there is no luggage or cargo in a parcel tray, the receiver 20 may receive the transmitter signal. On the other hand, when there is a passenger in the rear seat or there is luggage or cargo in the parcel tray, the driver may not see the rear view of the vehicle 1 through the rear-view mirror 16. In this case, the receiver 20 may not receive the transmitter signal (S120).

When the receiver 20 transmits information indicating the failure of the reception of the transmitter signal to the controller 40, the controller 40 controls the rear camera 22 to capture the rear view of the vehicle 1 and transmits an image about the captured rear view of the vehicle 1 to the controller 40 by operating the rear camera 22 (S130).

Thereafter, the controller 40 displays the image transmitted from the rear camera 22 on one or more displays 32 and 34 within the vehicle 1 (S140)

Accordingly, the driver may check the rear view of the vehicle 1 displayed on the displays 32 and 34.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A rear view system for a vehicle, comprising:
a transmitter configured to transmit a transmitter signal;
a receiver configured to receive the transmitter signal and transmit information on whether the transmitter signal is received;
a rear camera configured to capture a rear view of the vehicle, and transmit an image for the captured rear view of the vehicle;
one or more displays mounted within the vehicle; and
a controller configured to receive an image for a rear view of the vehicle from the rear camera in response to the reception of information indicating that the transmitter signal is not received from the receiver, and display the received image for the rear view of the vehicle on the one or more displays.

2. The rear view system of claim 1, wherein the transmitter signal is infrared ray.

3. The rear view system of claim 1, wherein the one or more displays are installed in at least one of a front window, a rear-view mirror, or an instrument panel.

4. The rear view system of claim 1, wherein the transmitter is installed in a rear-view mirror, and the receiver is installed in a lower portion of a rear window or under the rear window.

5. A rear view method for a vehicle, comprising:
transmitting, by a transmitter, a transmitter signal;
transmitting, by a receiver, information on whether the transmitter signal is received;
receiving, by a controller, an image for a rear view of the vehicle by operating a rear camera in response to reception of information indicating that the transmitter signal is not received; and
displaying, by the controller, the received image for the rear view of the vehicle on one or more displays.

6. The rear view method of claim 5, wherein the transmitter signal is infrared ray.

7. The rear view method of claim 5, wherein the one or more displays are installed in at least one of a front window, a rear-view mirror, or an instrument panel.

8. The rear view method of claim 5, wherein the transmitter is installed in a rear-view mirror, and the receiver is installed in a lower portion of a back window or under the back window.
